(19) United States
(12) Patent Application Publication
(10) Pub. No.: US 2011/0207021 A1
(43) Pub. Date: Aug. 25, 2011

(54) FUEL CELL ELECTROLYTE MEMBRANE

(75) Inventors: Tatsuo Fujinami, Shizuoka-ken (JP); Masayoshi Takami, Shizuoka-ken (JP)

(73) Assignees: TOYOTA JIDOSHA KABUSHIKI KAISHA, Toyota-shi (JP); NATIONAL UNIVERSITY CORPORATION SHIZUOKA UNIV., SHIZUOKA-SHI (JP)

(21) Appl. No.: 12/741,156

(22) PCT Filed: Mar. 25, 2009
(86) PCT No.: PCT/IB09/00592

§ 371 Date: May 3, 2010

(30) Foreign Application Priority Data
Mar. 26, 2008 (JP) 2008-080705

(51) Int. Cl. H01M 8/10

(52) U.S. Cl. 429/494

(57) ABSTRACT

An electrolyte membrane for a fuel cell includes a fluorine polymer electrolyte having a sulfonic acid group, and a copolymer which includes at least an aromatic ring and a cyclic imide that is condensed or not condensed with the aromatic ring, and in which an aromatic repeating unit having a structure in which the aromatic ring and the cyclic imide are bonded together directly or by only a single atom, is linked with a siloxane repeating unit having a structure that includes a siloxane structure.

### BACKGROUND OF THE INVENTION

1. Field of the Invention

The invention relates to an electrolyte membrane for a fuel cell, which can inhibit a change in its dimensions caused by the inflow and outflow of water.

2. Description of the Related Art

Fuel cells convert chemical energy directly into electric energy by supplying a fuel and an oxidant to two electrodes that are electrically connected together, and electrochemically oxidizing the fuel. Unlike thermal power generation, fuel cells are highly efficient in converting energy because they are not limited by the Carnot cycle. Fuel cells are normally formed of a stack of a plurality of single cells, each of which is basically made up of a membrane electrode assembly (MEA) in which an electrolyte membrane is sandwiched between a pair of electrodes. Among fuel cells, polymer electrolyte fuel cells having a polymer electrolyte membrane as the electrolyte membrane are particularly attractive as portable power supplies and power supplies for movable objects because they can easily be made small and operate at low temperatures.

In polymer electrolyte fuel cells, when hydrogen is used as the fuel, the reaction in the expression below takes place at the anode (i.e., the fuel electrode).

H₂→2H⁺+2e⁻

The electrons that are freed as a result of the expression above pass through an external circuit where they perform work at an external load and then reach the cathode (i.e., the oxidant pole). There, the protons created by the expression above move through the polymer electrolyte membrane from the anode to the cathode in a state hydrated with water from electro-osmosis.

Also, when oxygen is used as the oxidant, the reaction in the expression below takes place at the cathode.

2H⁺+(½)O₂+2e⁻→H₂O

The water produced at the cathode passes mainly through a gas diffusion layer, after which it is discharged out of the fuel cell. In this way, the fuel cell is a clean power source that emits nothing but water.

One major problem with currently known polymer electrolyte fuel cells is that the dimensions of the electrolyte membrane change with the inflow and outflow of water. In terms of durability, in particular, an excessive change in the dimensions of the electrolyte membrane that occurs with the inflow and outflow of water causes the electrolyte membrane to mechanically degrade. As a result, portions of the electrolyte membrane ultimately become damaged, resulting in cross leakage and thus a decrease in power generating performance.

To solve this problem, various attempts have been made to reinforce the electrolyte membrane using reinforcing material. For example, Japanese Patent Application Publication No. 2003-203648 (JP-A-2003-203648) describes a polymer electrolyte composite membrane that overcomes the drawback of reduced ion conductivity of a reinforced electrolyte membrane by having reinforcing material that conducts ions, compared to an electrolyte membrane composite membrane that has been reinforced with a polymer porous body that does not conduct ions.

However, in JP-A-2003-203648, even if the reinforcing material is introduced into the electrolyte membrane, it is still difficult to significantly inhibit a change in the dimensions of the electrolyte membrane as long as the electrolyte membrane itself has a sulfonic acid group that is greatly affected by water. Also, even if the ion conductivity of the reinforced electrolyte membrane does not decrease, no comparison is made with a perfluorocarbon sulfonic acid type resin membrane or the like, for example, which has come to be used as a related polymer electrolyte membrane, so the ways in which giving ion conductivity to the reinforcing material leads to an improvement over related technology are not clearly stated.

### SUMMARY OF THE INVENTION

This invention thus provides an electrolyte membrane for a fuel cell, in which a change in its dimensions is significantly inhibited compared with a polymer electrolyte membrane used in related art, and which has ion conductivity matching that of the related art.

One aspect of the invention relates to an electrolyte membrane for a fuel cell, which includes a fluorine polymer electrolyte having a sulfonic acid group; and a copolymer which includes at least an aromatic ring and a cyclic imide that is condensed or not condensed with the aromatic ring, and in which an aromatic repeating unit having a structure in which the aromatic ring and the cyclic imide are bonded together directly or by only a single atom, is linked with a siloxane repeating unit having a structure that includes a siloxane structure.

With an electrolyte membrane for a fuel cell having this kind of structure, there is compatibility between the fluorine polymer electrolyte having a sulfonic acid group and the copolymer having a cyclic imide. The sulfonic acid group is trapped by the imide group and is thus held in place without swelling by the inflow and outflow of water. As a result, a change in the dimensions of the membrane due to the inflow and outflow of water is able to be inhibited. Also, the π-π interaction between aromatic rings of the aromatic repeating units holds the copolymers together, thereby further inhibiting a change in the dimensions of the electrolyte membrane. Furthermore, the siloxane structure of the siloxane repeating unit within the copolymer enables the electrolyte membrane to maintain an appropriate amount of flexibility.

In the electrolyte membrane for a fuel cell of the invention, the copolymer may have a sulfonic acid group.

An electrolyte membrane for a fuel cell having this kind of structure is able to maintain good ion conductivity because the copolymer itself has ion conductivity.

In the electrolyte membrane for a fuel cell of the invention, the copolymer may have a molecular weight of 2,000 to 20,000.

With an electrolyte membrane for a fuel cell having this kind of structure, the copolymer has a suitable molecular weight so it will not elute due to hot water and is able to maintain good compatibility with the fluorine polymer electrolyte.

In the electrolyte membrane for a fuel cell of the invention, the fluorine polymer electrolyte content and the copolymer content may be such that, when the sum of the fluorine polymer electrolyte content and the copolymer content is 100 parts by weight, the fluorine polymer electrolyte is 95 to 70 parts by weight and the copolymer is 5 to 30 parts by weight.

With an electrolyte membrane for a fuel cell having this kind of structure, having a suitable fluorine polymer electrolyte content and a suitable copolymer content makes it possible to simultaneously inhibit a change in the dimensions of the membrane due to the inflow and outflow of water, and improve proton conductivity.

According to the invention, there is compatibility between the fluorine polymer electrolyte having a sulfonic acid group and the copolymer having a cyclic imide. The sulfonic acid group is trapped by the imide group and is thus held in place without swelling by the inflow and outflow of water. As a result, a change in the dimensions of the membrane due to the inflow and outflow of water is able to be inhibited. Also, the π-π interaction between aromatic rings of the aromatic repeating units holds the copolymers together, thereby further inhibiting a change in the dimensions of the electrolyte membrane. Furthermore, the siloxane structure of the siloxane repeating unit within the copolymer enables the electrolyte membrane to maintain an appropriate amount of flexibility.

### DETAILED DESCRIPTION OF EMBODIMENTS

An electrolyte membrane for a fuel cell according to an example embodiment of the invention includes a fluorine polymer electrolyte having a sulfonic acid group; and a copolymer which includes at least an aromatic ring and a cyclic imide that is condensed or not condensed with the aromatic ring, and in which an aromatic repeating unit having a structure in which the aromatic ring and the cyclic imide are bonded together directly or by only a single atom, is linked with a siloxane repeating unit having a structure that includes a siloxane structure.

A fluorine polymer electrolyte having a sulfonic acid group is an electrolyte polymer that has a nonaromatic fluorine polymer chain and a sulfonic acid group, and indicates a perfluorocarbon sulfonic acid type resin represented by Naflon (trade name, by DuPont), Ashiplex (trade name, by Asahi Kasei Co., Ltd.), and Flemion (trade name, by Asahi Glass Co., Ltd.) as examples which are on the market. However, in the fluorine polymer electrolyte here, that which is bonded to carbon does not necessarily all have to be fluorine, i.e., some of the fluorine may be replaced with hydrogen.

The aromatic repeating unit includes at least one cyclic imide and at least one aromatic ring that forms a chain structure of a main chain structure (the main chain in this case includes a polymeric side chain such as a graft chain), and has a chemical structure in which the aromatic ring contains a large part of the spatial spread of the repeating unit.

The aromatic ring may be either a mononuclear aromatic ring or a condensed multinucleated aromatic ring. With a multinucleated structure, there is no limit to the number of aromatic rings that are combined, but typically to facilitate synthesis, a mononuclear aromatic ring or a condensed multinucleated aromatic ring in which no more than three aromatic rings are condensed is preferable.

The atoms that form the aromatic ring have delocalized n electrons within the aromatic ring, in addition to a electrons that form the bonds between the atoms. The interaction between π electrons (i.e., the π-π interaction) causes the surfaces of aromatic rings to face one another and build up so they become stable. Therefore, copolymers having aromatic rings are mixed into the electrolyte membrane such that the copolymers hold one another in place because of the π-π interaction among aromatic rings. As a result, a change in the dimensions of the electrolyte membrane is able to be further suppressed.

The cyclic imide is a cyclic compound in which two hydrogen atoms of ammonia are substituted with an acyl group. Typically, the cyclic imide is derived from an acid anhydride and an amine. Therefore, the basic structural formula of the imide portion of the cyclic imide is —C(O)—N(R)—C(O)— (where R is alkyl or aryl or the like). The monoimides shown in formulas (1) through (6) below are example structural formulas of a cyclic imide.

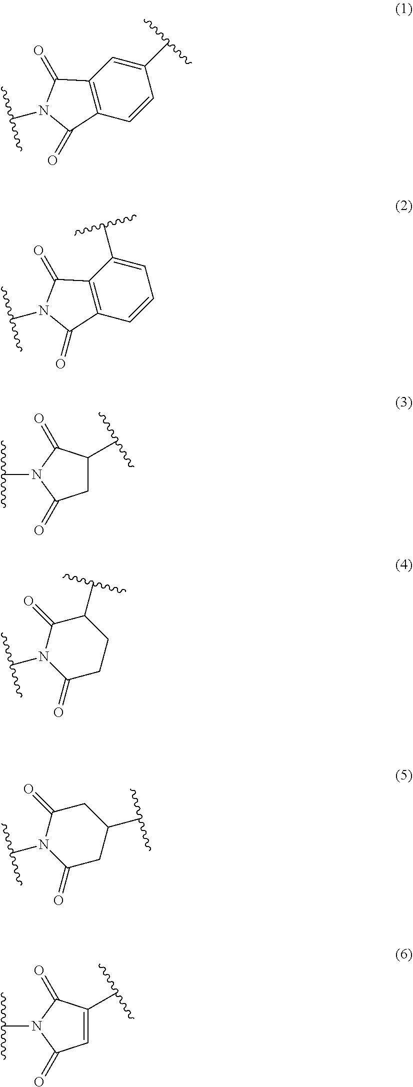

Also, the diimides shown in formulas (7) through (11) below, which are derived from tetracarboxylic anhydride, may also be used as the cyclic imide.

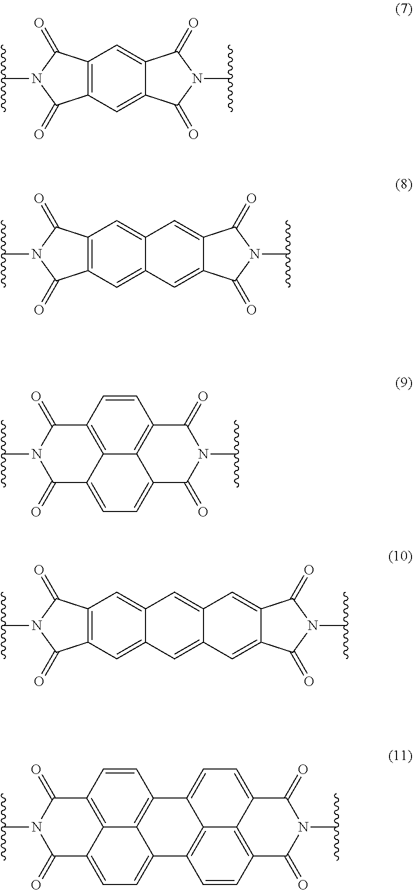

A polymer which has a phthalimide structure such as one of those shown in formulas (1) and (2), a succinimide structure such as that shown in formula (3), a glutarimide structure such as one of those shown in formulas (4) and (5), a maleimide structure such as that shown in formula (6), a benzenetetracarboxylic acid diimide structure such as that shown in formula (7), a naphthalenetetracarboxylic acid diimide structure such as one of those shown in formulas (8) and (9), an anthracenetetracarboxylic acid diimide structure such as that shown in formula (10), or a perylenetetracarboxylic acid diimide structure such as that shown in formula (11), is compatible with a fluorine polymer electrolyte having a sulfonic acid group. The sulfonic acid group is trapped by the imide group and is thus held in place without swelling by the inflow and outflow of water. As a result, a change in the dimensions of the membrane due to the inflow and outflow of water is able to be inhibited.

The cyclic imide may exist as a side change of repeating units, though preferably it forms a chain structure of a main chain structure by linking or condensing with the aromatic ring. The cyclic imide may be appear repeatedly any number of times in the copolymer or two or more different cyclic imide structures may form the same copolymer. The cyclic imide is preferably a cyclic imide that has condensed with the aromatic ring. Even more preferably, the cyclic imide is a cyclic imide that has condensed with a benzene ring, like one of the phthalimide structures in formulas (1) and (2).

The aromatic repeating unit may include an atom that bonds the aromatic ring and the cyclic imide together, a substituent group, a side chain, or a nonaromatic ring such as an alicyclic hydrocarbon. However, from the viewpoint of not losing π-π interaction and stiffness expected of an aromatic repeating unit, it is preferable that as many of the following conditions as possible be satisfied, and more preferably, that at least Condition 1 below be satisfied.

Condition 1: An aromatic ring and a cyclic imide are preferably directly bonded together (including condensed) or bonded together by only one atom. However, the chemical structure that links the aromatic ring and the cyclic imide may have a substituent group or a side chain, as long as the chemical structure does not include two or more atoms that are bonded together in the direction of a chain that links a ring and a ring together. For example, when an aromatic ring and a cyclic imide are bonded together by a 2,2-propylidene group (which can also be expressed as a dimethylmethylene group), they are bonded together by only a single atom.

Condition 2: A substituent group or a side chain may be either chain-shaped or ring-shaped, and is preferably small. More specifically, the number of atoms that make up the substituent group or side chain is preferably such that the total number, excluding hydrogen atoms, is no more than three for each individual substituent group or side chain.

Condition 3: When the aromatic repeating unit has a nonaromatic ring, that nonaromatic ring preferably exists as a pendant structure of a polymer chain. Also, the number of nonaromatic rings included in the aromatic repeating unit is preferably fewer than the number of aromatic rings. The number of nonaromatic rings included in one aromatic repeating unit is preferably no more than two, and more preferably, no more than one.

The siloxane repeating unit has a chemical structure that includes a polysiloxane structure in which two or more siloxane structures (—(R)₂Si—O—) are linked together within a chain structure that forms a main chain structure (a main chain structure in this case includes a polymeric side chain such as a graft chain). The polysiloxane structure is expressed by a general expression such as a chain polysiloxane structure —(R)₂Si—O—{(R)₂Si—O—}ₙ—(R)₂Si—, or a cyclic polysiloxane structure (—(R)₂Si—O—)ₙ or the like. In particular, a polysiloxane structure in which R is a methyl group is generally well known, though in other examples R may be a straight or branched alkyl group with a carbon number of 1 to 8, such as an ethyl group, an n-propyl group, an isopropyl group, an n-butyl group, an isobutyl group, a tert-butyl group, a sec-butyl group, an n-pentyl group, or an n-hexyl group, or a hydroxyalkyl group with a carbon number of 1 to 8, such as a hydroxymethyl group or a hydroxyethyl group or the like.

A polysiloxane structure of a siloxane repeating unit is preferably made up of 3 to 20 siloxane structures that are linked together in order to make it easier to adjust the flexibility of the electrolyte membrane. The chain of the siloxane structure may be broken partway through the polysiloxane structure, but in this case it is preferable that a single repeating unit have at least one part in which there are 2 to 20 siloxane structures that are linked together.

The siloxane repeating unit may have a structure made of a linking group with another repeating unit at one or both ends. Examples of a linking group that exists at an end portion of the siloxane repeating unit include, in addition to a bivalent hydrocarbon group, a divalent organic group having an ester group or an ether group or the like, an organic group having an ester group or an ether group or the like, and a hydrocarbon group that includes a hetero atom. In the case of a hydrocarbon group, the size of the linking group may be, for example, a hydrocarbon group in which the number of carbon atoms linked in the direction of the main chain is approximately 1 to 8. Even if the linking group includes a hetero atom, it is preferable that the number of atoms liked in the direction of the main chain is approximately 1 to 8 as well.

With a carbon-carbon bond which is the main chain structure of a normal hydrocarbon chain, the bond angle of C—C—C is 109° and the bond distance of C—C is 0.140 nm. In contrast, with a silicon-oxygen bond which is the main chain structure of a polysiloxane structure, the bond angle of Si—O—Si is wider, at 143°, and the bond distance of Si—O is longer, at 0.165 nm, so there is little rotation barrier (the energy of the rotation barrier is 0.8 kJmol⁻¹) and the silicon-oxygen bond is able to rotate freely. That is, the polysiloxane structure can maintain a suitable amount of flexibility compared with a normal hydrocarbon chain.

The copolymer may be a block copolymer in which a block of a given number of linked aromatic repeating units is copolymerized with a block of the same number of linked siloxane repeating units, or it may be a copolymer in which different repeating units are alternately polymerized. Also, the copolymer may be a random copolymer in which there is absolutely no order to the arrangement of repeating units.

The copolymer may also include other repeating units. However, if there are too many of those other repeating units, the properties expected from the copolymer may not be sufficiently exhibited. Therefore, the percentage of the other repeating units in the copolymer, with respect to the copolymer, is preferably no more than 30 mol %, and more preferably no more than 10 mol %. In fact, it is even more preferable that the copolymer contain no other repeating units.

The copolymer preferably has a sulfonic acid group. This is because when the copolymer itself has ion conductivity, the electrolyte membrane containing that copolymer is able to maintain good ion conductivity. When obtaining the copolymer having a sulfonic acid group, the sulfonic acid group can be introduced into the copolymer after the copolymer has been synthesized or the sulfonic acid group can be introduced after being blended with the fluorine polymer electrolyte. However, if the sulfonic acid group is introduced under an acidic or a basic condition, the imide bond described above may hydrolyze, causing the polymer to break. Therefore, the copolymer more preferably has a sulfonic acid group from the monomer phase during or before polymer synthesis. Incidentally, the ion exchange capacity of the copolymer having the sulfonic acid group is preferably 0.1 to 1.5 meq/g.

The molecular weight of the copolymer is preferably 2,000 to 20,000. If the molecular weight of the copolymer is less than 2,000, a change in the dimensions of the membrane from the inflow and outflow of water will be unable to be suppressed. In addition, the copolymer tends to elute due mainly to hot water. Also, if the molecular weight of the copolymer exceeds 20,000, the compatibility between the fluorine polymer electrolyte and the copolymer is low so the effect of the invention is unable to be obtained in this case as well. Incidentally, the molecular weight of the copolymer is more preferably 2,000 to 15,000, and most preferably 2,000 to 10,000.

The fluorine polymer electrolyte content and the copolymer content are preferably such that, when the sum of the fluorine polymer electrolyte content and the copolymer content is 100 parts by weight, the fluorine polymer electrolyte is 95 to 70 parts by weight and the copolymer is 5 to 30 parts by weight. If the fluorine polymer electrolyte is less than 70 parts by weight, an electrolyte membrane with sufficient proton conductivity will be unable to be obtained. If the copolymer is less than 30 pails by weight, a change in the dimensions of the membrane from the inflow and outflow of water will be unable to be sufficiently suppressed. Incidentally, more preferably, the fluorine polymer electrolyte is 95 to 75 parts by weight and the copolymer is 5 to 25 parts by weight, and most preferably, the fluorine polymer electrolyte is 95 to 80 parts by weight and the copolymer is 5 to 20 parts by weight.

A preferable method for manufacturing the electrolyte membrane includes dissolving the fluorine polymer electrolyte and the copolymer in an appropriate solvent, then casting the liquid solution onto a smooth surface such as a glass plate and drying it under a flow of inert gas such as nitrogen gas or argon gas. Incidentally, if there is solvent remaining in the membrane, it may also be high-temperature vacuum dried. A mixed solvent of dimethylsulfoxide (DMSO), N-methylpyrrolidone (NMP), dimethylacetamide (DMA), or 2-propanol, ethanol, or the like may be used as the solvent at this time. The thickness of the electrolyte membrane is 5 to 200 μm, preferably 5 to 80 μm, and more preferably 10 to 30 μm. The electrolyte membrane is preferably thin in order to improve proton conductivity, but if it is too thin, it will not be able to separate gases as well, such that the amount of aprotic hydrogen that passes through it will increase, and in an extreme case, cross leakage will occur. The method for manufacturing the electrolyte membrane is not limited to this. For example, the electrolyte membrane may also be manufactured according to conventionally used methods, of which the melt extrusion method and the doctor blade method are main examples.

Hereinafter, a classic example of the example embodiment of the invention will be described in detail. In this example, a perfluorocarbon sulfonic acid type resin (such as Nafion (trade name)) is used as a fluorine polymer electrolyte having a sulfonic acid group, and poly(dimethylsiloxane)etherimide (hereinafter abbreviated as “PDSEI”; by Gelest, Inc; product number SSP-85) shown in formula (12) below is used as a polymer having a cyclic imide, an aromatic ring, and a siloxane structure. This PDSEI has a crystalline portion and a noncrystalline portion within the electrolyte membrane.

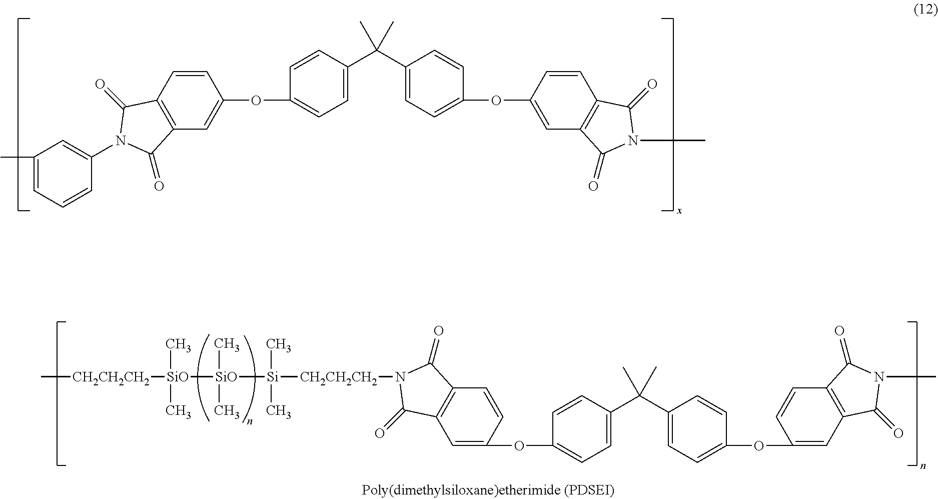

The values of x, y, and n, which are the degrees of polymerization of the PDSEI shown in formula (12), may be set freely as long as the molecular weight of the PDSEI is 2,000 to 20,000. However, in view of the respective functions of the aromatic repeating unit and the siloxane repeating unit described above, it is preferable that x=1 to 3, y=1 to 12, and n=8 to 10. A polymer in which a sulfonic acid group has been introduced into the PDSEI beforehand may also be used. In this case, a polymer in which a sulfonic acid group has been introduced into the PDSEI beforehand may be synthesized by a dehydration condensation reaction of bisphenol A and a polydimethylsiloxane having an amino group at both ends of the polymer, after first having introduced a sulfonic acid group into a benzene ring of a phthalic acid derivative using chlorosulfonic acid, fuming sulfuric acid (i.e., oleum), or concentrated sulfuric acid. However, when reacting a sulfonation agent of chlorosulfonic acid or the like with PDSEI, it is highly likely that the imide bond will hydrolyze and the polymer will break. Therefore, direct sulfonation of the PDSEI is not preferable when the sulfonation level is high.

When perfluorocarbon sulfonic acid type resin and PDSEI together total 100 parts by weight, the electrolyte membrane for a fuel cell according to this example embodiment of the invention is made by forming a membrane by dissolving and mixing the perfluorocarbon sulfonic acid type resin and the PDSEI into a suitable solvent such that the perfluorocarbon sulfonic acid type resin is 95 to 70 parts by weight and the PDSEI is 5 to 30 parts by weight. Incidentally, when using a polymer in which a sulfonic acid group has been introduced into the PDSEI beforehand, the perfluorocarbon sulfonic acid type resin may be 95 to 70 parts by weight and the polymer in which the sulfonic acid group has been introduced into the PDSEI beforehand may be 5 to 30 parts by weight.

With an electrolyte membrane for a fuel cell having this kind of structure, there is compatibility between the fluorine polymer electrolyte having a sulfonic acid group and the copolymer having a cyclic imide. The sulfonic acid group is trapped by the imide group and is thus held in place without swelling by the inflow and outflow of water. As a result, a change in the dimensions of the membrane due to the inflow and outflow of water is able to be inhibited. Also, the π-π interaction between aromatic rings of the aromatic repeating units holds the copolymers together, thereby further inhibiting a change in the dimensions of the electrolyte membrane. Furthermore, the siloxane structure of the siloxane repeating unit within the copolymer enables the electrolyte membrane to maintain an appropriate amount of flexibility. Also, the electrolyte membrane that contains the copolymer is able to maintain good ion conductivity because the copolymer itself has the sulfonic acid group. In addition, the copolymer has a suitable molecular weight so it will not elute due to hot water and is able to maintain good compatibility with the fluorine polymer electrolyte. Having a suitable content of fluorine polymer electrolyte and copolymer makes it possible for the electrolyte membrane according to the example embodiment of the invention to simultaneously inhibit a change in the dimensions of the membrane due to the inflow and outflow of water, and improve proton conductivity.

### 1. STRUCTURE OF THE ELECTROLYTE MEMBRANE

### Example 1

A semi-transparent flexible electrolyte membrane was obtained by the following method. That is, 0.05 g (molecular weight of 20,000; 5 parts by weight) of PDSEI and 0.95 g (95 parts by weight) of Nafion (trade name; by DuPont) which is a type of perfluorocarbon sulfonic acid type resin was dissolved in 18 mL of DMA in a nitrogen atmosphere in an eggplant flask, and the resultant liquid solution was agitated for 2 hours at room temperature in a nitrogen atmosphere. After agitation, the agitator is extracted and the liquid solution was cast onto a glass petri dish, where it was left for 6 hours at 80° C. under a flow of nitrogen, whereupon a wet gel membrane was obtained. Then to remove any solvent remaining in the wet gel membrane, the wet gel membrane was dried under reduced pressure for 2 hours in a vacuum at 120° C., whereupon the semi-transparent flexible electrolyte membrane was obtained.

### Example 2

A second semi-transparent flexible electrolyte membrane was obtained by the same method and under the same conditions as in Example 1, except that 0.2 g (molecular weight of 20,000; 20 parts by weight) of PDSEI was used instead of 0.05 g (molecular weight of 20,000; 5 parts by weight), and 0.8 g (80 parts by weight) of Nafion (trade name; by DuPont) was used instead of 0.95 g (95 parts by weight).

### Example 3

A third semi-transparent flexible electrolyte membrane was obtained by the same method and under the same conditions as in Example 1, except that 0.3 g (molecular weight of 20,000; 30 parts by weight) of PDSEI was used instead of 0.05 g (molecular weight of 20,000; 5 parts by weight), and 0.7 g (70 parts by weight) of Nafion (trade name; by DuPont) was used instead of 0.95 g (95 parts by weight).

### 2. MEASURING THE WATER ABSORPTION RATE AND THE RATE OF DIMENSION CHANGE OF THE ELECTROLYTE MEMBRANE

Two electrolyte membranes of each example, i.e., Examples 1, 2, and 3, formed 10 mm long, 10 mm wide and 0.05 mm thick were prepared. In addition, two membranes made of Nafion (Nafion 117, by Aldrich), which is one type of perfluorocarbon sulfonic acid type resin on the market, were also prepared. One of each type of these electrolyte membranes was left standing under a first condition (in water at 25° C.), and the other of each type was left standing under a second condition (at atmospheric pressure at 25° C.). Then, the weight of each membrane was measured using an electronic balance and the dimensions (thickness) of each membrane were measured using a micrometer. The water absorption rate is defined as being equal to [{(weight under first condition)−(weight under second condition)}/(weight under second condition)]×100. Also, the rate of dimension change (i.e., the change in the direction of membrane thickness) is defined as being equal to [{(dimensions under first condition)−(dimensions under second condition)}/(dimensions under second condition)]×100.

### 3. MEASURING THE PROTON CONDUCTIVITY OF THE ELECTROLYTE MEMBRANE

The proton conductivity of the electrolyte membranes in each example, i.e., Examples 1, 2, and 3, and the Nafion membranes were measured by measuring the AC (alternating-current) impedance at a frequency of 10 kHz. Incidentally, the electrolyte membranes of the example embodiment and the Nafion membranes were left standing for 2 hours at 60° C. at 95% relative humidity and the impedance was measured after equilibrium was reached.

### 4. EVALUATION OF THE WATER ABSORPTION RATE, THE RATE OF DIMENSION CHANGE, AND THE PROTON CONDUCTIVITY OF THE ELECTROLYTE MEMBRANE

Table 1 shows the water absorption rate, the rate of dimension change (i.e., the change in the direction of membrane thickness), and the proton conductivity of the electrolyte membranes of Examples 1 to 3 and the Nafion membranes (referred to as Comparative example 1).

| | Water | Change in direction | |
|---|---|---|---|
| | absorption | of membrane | Proton conductivity |
| | rate [%] | thickness [%] | (60° C.) [S/cm] |
| Example 1 | 20.9 | 3.6 | 6.3 × 10⁻² |
| Example 2 | 21.6 | 5.3 | 6.0 × 10⁻² |
| Example 3 | 17.4 | 1.7 | 6.6 × 10⁻² |
| Comparative | 24.7 | 12.2 | 6.2 × 10⁻² |
| example 1 | | | |

From Table 1, it is evident that the water absorption rate is a lower value in all of Examples 1 to 3 than it is in Comparative example 1 in which the Nafion membrane is used. From this, it is evident that the electrolyte membrane containing PDSEI of a suitable molecular weight at a suitable ratio is less susceptible to swelling caused by water than the Nafion membrane is. Also, with regards to the rate of dimension change, the electrolyte membranes of Examples 1 to 3 have significantly lower values for the change in the direction of membrane thickness than the Comparative example 1 in which the Nafion membrane is used does. Therefore, compared to the Nafion membranes, the electrolyte membranes of the examples are better able to inhibit a change in their dimensions due to the fact that they contain PDSEI of a suitable molecular weight at a suitable ratio. Moreover, with regards to proton conductivity, all of Examples 1 to 3 have values substantially similar to that of the Comparative example 1 in which the Nafion membrane is used. This shows that good proton conductivity is able to be maintained even when the electrolyte membrane contains PDSEI of a suitable molecular weight at a suitable ratio.

### 5. CONCLUSION

Having the electrolyte membranes of the examples contain PDSEI of a suitable molecular weight makes it possible to maintain good proton conductivity while significantly inhibiting swelling from water as well as a change in dimensions that occurs from that swelling.

1. An electrolyte membrane, comprising:
a fluorine polymer electrolyte having a sulfonic acid group; and
a copolymer comprising at least an aromatic ring and a cyclic imide that is condensed or not condensed with the aromatic ring, and in which an aromatic repeating unit having a structure in which the aromatic ring and the cyclic imide are bonded together directly or by only a single atom, is linked with a siloxane repeating unit having a structure that includes a siloxane structure.

2. The electrolyte membrane according to claim 1, wherein the copolymer comprises a sulfonic acid group.

3. The electrolyte membrane according to claim 1, wherein the copolymer has a molecular weight of from 2,000 to 20,000.

4. The electrolyte membrane according to claim 3, wherein the copolymer has a molecular weight of from 2,000 to 15,000.

5. The electrolyte membrane according to claim 4, wherein the copolymer has a molecular weight of from 2,000 to 10,000.

6. The electrolyte membrane according to claim 1, wherein the fluorine polymer electrolyte content and the copolymer content are such that, when the sum of the fluorine polymer electrolyte content and the copolymer content is 100 parts by weight, the fluorine polymer electrolyte is 95 to 70 parts by weight and the copolymer is 5 to 30 parts by weight.

7. The electrolyte membrane according to claim 6, wherein the fluorine polymer electrolyte is 95 to 80 parts by weight and the copolymer is 5 to 20 parts by weight.

8. The electrolyte membrane according to claim 1, wherein the copolymer is a poly(dimethylsiloxane)etherimide.

9. The electrolyte membrane according to claim 1, wherein the percentage of a repeating unit included in the copolymer, other than the aromatic repeating unit and the siloxane repeating unit, with respect to the copolymer is no more than 30 mol %.

10. The electrolyte membrane according to claim 9, wherein the percentage of a repeating unit included in the copolymer, other than the aromatic repeating unit and the siloxane repeating unit, with respect to the copolymer is no more than 10 mol %.

11. The electrolyte membrane according to claim 10, wherein the copolymer includes no repeating unit other than the aromatic repeating unit and the siloxane repeating unit.

12. The electrolyte membrane according to claim 1, wherein a polysiloxane structure of the siloxane repeating unit is made of 3 to 20 siloxane structures that are linked together.

13. A fuel cell comprising:
an anode;
the electrolyte membrane according to claim 1; and
a cathode.
